(19) United States
(12) Patent Application Publication
(10) Pub. No.: US 2025/0270236 A1
(43) Pub. Date: Aug. 28, 2025

(54) TRYPTAMINE ANALOGUES

(71) Applicant: Green Sky Creations LLC, Seattle, WA (US)

(72) Inventor: Brad Douglass, Black Diamond, WA (US)

(73) Assignee: Green Sky Creations LLC, Seattle, WA (US)

(21) Appl. No.: 18/856,521

(22) PCT Filed: Apr. 6, 2023
(86) PCT No.: PCT/US2023/017733

§ 371 Date: Oct. 11, 2024

Related U.S. Application Data
(63) Continuation of application No. 17/720,229, filed on Apr. 13, 2022, now abandoned.

(51) Int. Cl. C07F 5/02

(52) U.S. Cl. CPC C07F 5/027

(57) ABSTRACT

The current disclosure provides tryptamine analogues including tryptamine analogues having a boron moiety. Boron is present in at least some of these tryptamine analogues. Uses of the tryptamine analogues of the current disclosure include uses in medical treatment, such as treatment for cancer, brain cancer, and use as a psychoactive treatment agent.

### FIELD OF THE DISCLOSURE

The current disclosure provides boron tryptamine analogues. Members of this group of compounds can have neuroactive properties, psychoactive properties or potential use as boron delivery compounds.

### BACKGROUND

Tryptamines are a class of molecules of burgeoning interest. Most tryptamines are sufficiently lipophilic and of low molecular weight to cross the blood-brain barrier via passive diffusion. Traversing the blood-brain barrier is one of the major challenges that central nervous system therapeutics must overcome. In addition, tryptamines are metabolized in the human digestive tract by monoamine oxidases (MAO) presenting another barrier to maintaining the oral activity of therapeutics containing the tryptamine motif.

Boron Neutron Capture Therapy (BNCT) relies upon targeting molecules containing boron (10B) to a cancerous mass and then directing a beam of neutrons to the cancerous mass. The boron molecules then absorb the neutrons (i.e. alpha particles) thus creating heat in the process, which ablates surrounding tissue. Currently, only two BNCT delivery agents are approved by FDA—boronophenylalanine and sodium borocaptate—and each has its limitations. There is a pressing need for additional options that are both safe and effective at delivering boron preferentially to certain areas of the brain and/or to fast-growing tissues.

Belief in the therapeutic potential of psychoactive compounds is currently experiencing a renaissance. Despite increased attention in this area, there remains insufficient understanding about what steric or electronic facets of molecules are responsible for their often idiosyncratic psychoactive effects. In addition, psychoactive tryptamine compounds, such as dimethyltryptamine, are often orally inactive due to metabolization by MAOs in the human digestive tract. This often leads to additional measures becoming necessary, such as co-administration with an MAO inhibitor (MAOi), to secure oral activity. There exists much interest in non-toxic compounds that can overcome some of these deficiencies of the tryptamine class while also maintaining CNS effects.

### SUMMARY

The current disclosure provides tryptamine analogues including tryptamine analogues that comprise a boron moiety. Tryptamine analogues can have psychoactive properties that can be used for treating psychological maladies and can also have other properties, such as acting as a serotonin analogue and as a proteasome inhibitor, providing biological functionality in human and animal bodies. Boron provides additional functionality, including functioning as a neutron absorber, which can be used in such applications as boron neutron capture therapy (BNCT.) The combination of boron and tryptamine can have additional benefits, such as by treating both a serious disease (e.g. cancer, etc.) and providing benefits for psychological problems (e.g. depression, anxiety, etc.) related to the onset of the disease.

### DETAILED DESCRIPTION

Embodiments of compounds disclosed herein include the compounds represented by Formulas I-V as well as salts, stereoisomers (present as optically pure, optically mixed or racemic mixtures), hydrates, solvates, and prodrugs thereof; uses of these compounds, including salts, stereoisomers (present as optically pure, optically mixed or racemic mixtures), hydrates, solvates and prodrugs can be used as drugs, prodrugs, chemical intermediates (for preparation of drugs or other compounds), tags, microbe inhibitor (for yeasts and other microbes), saccharide sensors (such as of glucose in blood or ocular fluid), catechol-based biomolecule sensors (such as dopamine) and pH modulators:

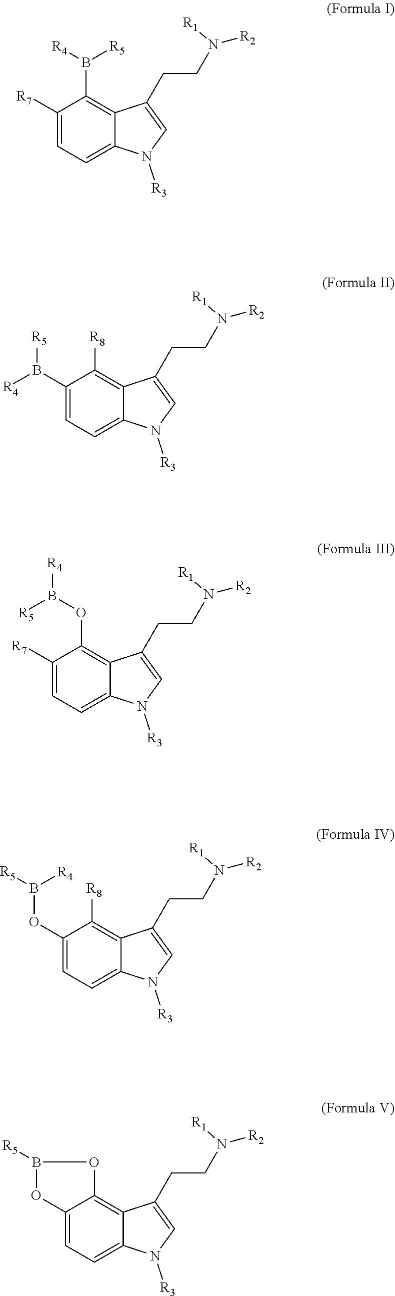

### Where,

R₁ and R₂, are independently H, C₁ to C₁₂ hydrocarbon, or C₁ to C₁₂ substituted hydrocarbon;
R₃ is independently H, C₁ to C₁₂ hydrocarbon, C₁ to C₁₂ substituted hydrocarbon, or a protecting group;
R₄ and R₅ are independently halogen, H, OH, OR₆, C₁ to C₁₂ hydrocarbon, C₁ to C₁₂ substituted hydrocarbon, C₅ to C₁₂ aryl, C₂ to C₁₂ heterocyclic, C₄ to C₁₂ heteroaryl;
R₆ is a hydrocarbon or substituted hydrocarbon; and
R₇ and R₈ are independently halogen, H, OH, OR₆, C₁ to C₁₂ hydrocarbon or C₁ to C₁₂ substituted hydrocarbon;
   where the terms “hydrocarbon”, “substituted hydrocarbon”, “protecting group”, and “halogen” have the meanings explained herein.

In an embodiment of any one of compounds of Formulas I-V identified herein, the hydrocarbon of R₁ or R₂ is selected independently from methyl, ethyl, propyl, isopropyl and butyl.

In an embodiment of any one of compounds of Formulas I-V identified herein, the hydrocarbon of R₆ is selected independently from C₁ to C₁₂ hydrocarbon.

In an embodiment of any one of compounds of Formulas I-V identified herein, the substituted hydrocarbon of R₆ is selected independently from C₁ to C₁₂ substituted hydrocarbon.

In an embodiment of any one of compounds of Formulas I-V identified herein, the hydrocarbon of R₁, R₂, R₃, R₄, R₅, R₆, R₇, or R₈, is selected independently from C₁ to C₆.

In an embodiment of any one of compounds of Formulas I-V identified herein, the substituted hydrocarbon of R₁, R₂, R₃, R₄, Rs, R₆, R₇, or R₈, is selected independently from C₁ to C₆.

In an embodiment of any one of compounds of Formulas I-V identified herein, R₃ is H.

In an embodiment of any one of compounds of Formulas I-V identified herein, R₄ and R₅ are independently halogens, and in an embodiment, a salt of Formula I-V is a trifluoroborate salt, such as a potassium trifluoroborate salt.

In an embodiment of any one of compounds of Formulas I-V identified herein, a protecting group of R₃ is an amine protecting group.

In an embodiment of compounds of Formulas I-V identified herein, a protecting group of R₃ is selected from the group consisting of tert-butyloxycarbonyl (BOC), fluorenylmethoxycarbonyl (Fmoc), benzyloxymethyl acetal (BOM), methoxymethyl group (MOM), benzyl, or acetyl.

In an embodiment of compounds depicted in Formulas I-V identified herein, the compound can further comprise an additional protecting group at a location other than R₃ to protect an amine nitrogen. In an embodiment, the additional protecting group can be an amine protecting group. In an embodiment, the additional protecting group can be selected from the group consisting of tert-butyloxycarbonyl (BOC), fluorenylmethoxycarbonyl (Fmoc), benzyloxymethyl acetal (BOM), methoxymethyl group (MOM), benzyl, or acetyl.

Molecules that fall into the subclasses of boron tryptamine analogues depicted by Formulas I and Ill are particularly useful as psilocin prodrugs with oral activity. Exemplary compounds in this group include molecules 1 and 3:

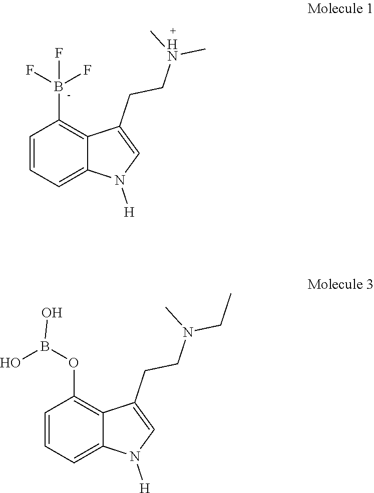

Molecules that fall into the subclasses of boron tryptamine analogues depicted by Formulas II and IV are particularly useful as BNCT agents that minimize the psychoactive effects, especially at higher concentrations. Exemplary compounds in this group include molecules 2 and 4:

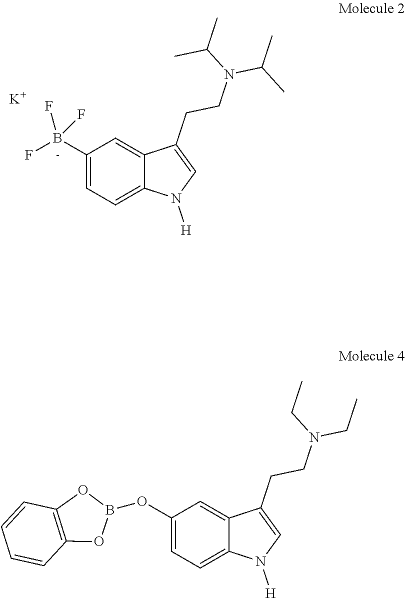

Molecules that fall into the subclass of boron tryptamine analogues depicted by Formula V will balance psychoactive effects with utility as BNCT agents. Exemplary compounds in this group include molecules 5 and 6, where R is alkyl, aryl or heteroaryl in molecule 6:

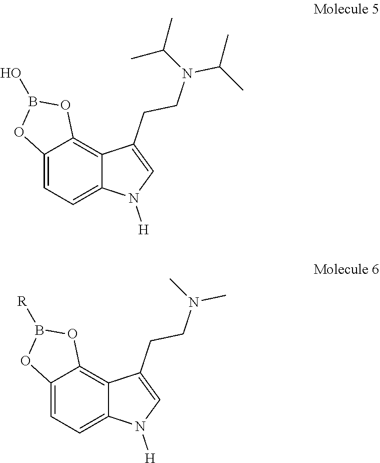

### Methods for Making the Boron Tryptamine Analogues

Embodiments of methods of preparing the compounds of Formulas I-V (or a salt, stereoisomer, hydrate, solvate, or prodrug thereof) as well as related compounds are described below.

The compounds described herein can be synthesized using the methods described below, or similar methods, together with synthetic methods known in the art of synthetic organic chemistry, or by variations thereon as appreciated by those skilled in the art. Preferred methods may include, but are not limited to, those described below. The reactions can be performed in a solvent or solvent mixture and a gas interface (oxygen-containing, inert, etc.) appropriate to the reagents and materials employed and suitable for the transformations being affected can be used.

It will be understood by those skilled in the art of organic synthesis that the functionality present on the molecule should be consistent with the transformations proposed. This will sometimes require a judgment, well within the skill of a skilled artisan, to modify the order of the synthetic steps or to select one particular process example over another in order to obtain a desired compound of the invention.

Protection and de-protection in the processes below may be carried out by procedures generally known in the art (see, for example, Greene, T. W. et al, Protecting Groups in Organic Synthesis, 3rd Edition, Wiley (1999)). General methods of organic synthesis and functional group transformations are found in: Trost, B. M. et al, eds., Comprehensive Organic Synthesis: Selectivity, Strategy & Efficiency in Modern Organic Chemistry, 1′ Edition, Pergamon Press, New York, N.Y. (1991); March, J., Advanced Organic Chemistry. [0023]4- and 5-hydroxy-tryptamines can be made by adapting methods described in the art by Baumann et al. (Beilstein 2011, 7, 442) Shulgin (The Vaults of Erowid: TiHKAL: The Chemical Story, by Alexander and Ann Shulgin) and Fricke (Eur Chem J 2019, 25, 897), as well as in U.S. Pat. No. 3,075,992 and Chen (JOC 1994, 3738), all of which are incorporated by reference herein for methods of making and modifying tryptamines and tryptamine analogues.

For example, succinate prodrug compounds described herein may be prepared using the synthetic route as outlined in Route 1 starting from the corresponding hydroxy-indole and the diacid anhydride. The reaction conditions such as temperature, time, choice of solvent and workup procedures are selected which may be suitable for experimental conditions recognized by one skilled in the art. Restrictions to the substituents that are compatible with the reaction conditions will be readily apparent to one skilled in the art and alternate or analogous methods must then be used.

### Route 1

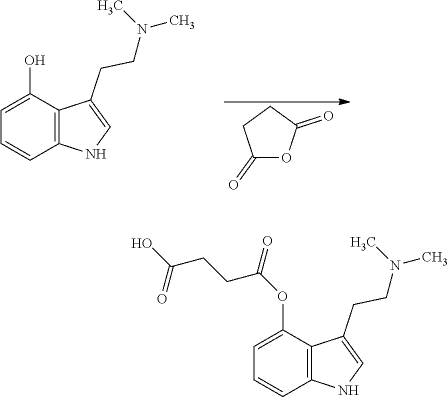 [SMILES: CN(C)CCc1c[nH]c2cccc(O)c12 ; O=C1CCC(=O)O1 ; CN(C)CCc1c[nH]c2cccc(OC(=O)CCC(=O)O)c12]

Other diacid prodrugs may be prepared using other diacid anhydrides, as may be readily visualized by those skilled in the art.

A glutarate prodrug compound may be made using glutaric anhydride, using Route 2 below:

### Route 2

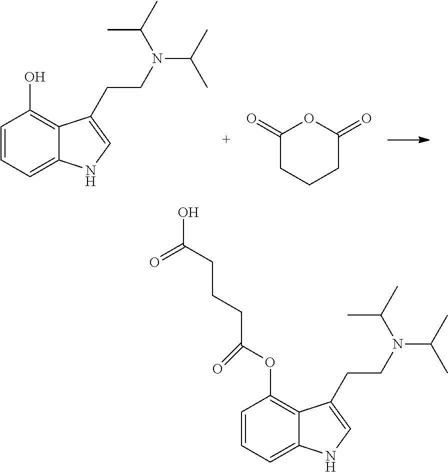 [SMILES: CC(C)N(CCc1c[nH]c2cccc(O)c12)C(C)C ; O=C1CCCC(=O)O1 ; CC(C)N(CCc1c[nH]c2cccc(OC(=O)CCCC(=O)O)c12)C(C)C]

One skilled in the art may readily select suitable conditions and solvents. The reaction with the diacid anhydride may take place in dichloromethane and triethylamine, or pyridine. In some embodiments, the solvent contains a base with pKa greater than 4 but less than 9. If pyridine is used, the product precipitates directly from the reaction mixture in pure form as the zwitterion.

The solid zwitterion may be converted to a suitable salt, for example, a hydrochloride salt, by addition of anhydrous HCl (gas) in a suitable solvent or by triturating in anhydrous ether HCl or dioxane HCl.

Synthesis of the diacid hemiester prodrugs may also be produced using a variety of other methods and techniques well known to those skilled in the art (Rautio, Nature Rev in Drug Discovery 2018, 17, 559), for example, using anhydride or doubly-activated forms of the diacids, such as dichloride, di-N-hydroxysuccinimide (using dicyclohexylcarbodiimide (DCC) or 1-Ethyl-3-(3-dimethylaminopropyl)carbodiimide (EDC), N-hydroxysuccinimide and DMAP), di-imizadolide (using carbonyldimidizole), or other activated form of the diacid with the hydroxy form of the active heterocyclic species. When using the diactivated forms, it is preferable to use a 2-25-fold excess of the doubly activated diacid to avoid covalently binding 2 tryptamines to the diacid.

Similarly, one skilled in the art can apply these methods to boron analogues of tryptamine.

Substituted tryptamines are understood by those skilled in the art to be synthetically accessible from a variety of substituted indoles using oxalyl chloride and subsequent lithium aluminum hydride reduction via the Speeter-Anthony Synthesis with relatively broad generalizability to R₇ and R₈ functional groups (within the alkyl and halide class) in addition to general applicability of alky, substituted alkyl and aryl functional groups for R₁ and R₂ as shown in Route 3 below:

### Route 3

### Speeter-Anthony Synthesis

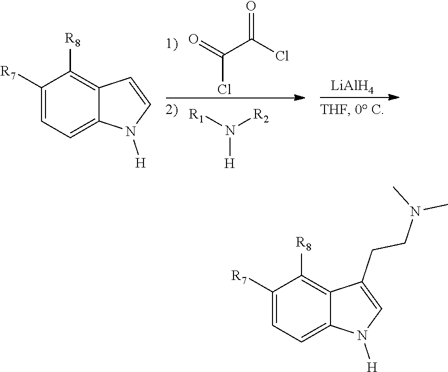

A broad range of substituted tryptamines are also accessible via the biosynthetic route reported by Buller and colleagues (McDonald, 2019) A. D. McDonald, L. J. Perkins, A. R. Buller, ChemBioChem 2019, 20, 1939. https://doi.org/10.1002/cbic.201900069, which is incorporated herein by reference for its teaching of the synthesis of tryptamines biocatalytically from substituted and readily accessible indoles with different chemical compatibilities than traditional chemical synthetic routes as shown in Route 4:

### Route 4

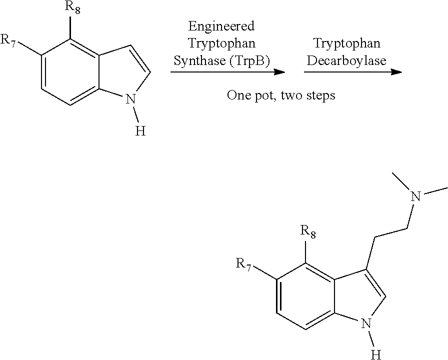

### Processing Examples

The following process Examples A-1 are related to preparation of compounds related to those of Formulas I-V. These process examples demonstrate methods of modifying various groups attached to or that can be attached to a tryptamine core. These Examples demonstrate methods adaptable for preparing the compounds described in this disclosure with Examples A-E generally related to the syntheses of Formula I compounds, Examples F-J related to the syntheses of Formula II compounds, Example K related to the syntheses of Formula III compounds, Example L related to the syntheses of Formula IV compounds and Example M related to the syntheses of Formula V compounds.

Example A. Preparation of 4-iodo-N,N-dimethyltryptamine from 4-iodotryptamine [0035]4-iodotryptamine (1 mole, 194.7 grams) is stirred in 1 L of methanol and chilled to −10° C. Sodium borohydride (2.5 mole, 94.6 grams) in 0.5 L of distilled water and formaldehyde (8.0 mole, 240.2 grams) as a 37% aqueous solution (stabilized with methanol) are then added at equal rates to the stirred and chilled 4-iodotryptamine solution at a rate that maintains the reaction temperature below 0° C. Upon adding the entirety of the sodium borohydride and formaldehyde solutions, the reaction is then stirred for an additional one hour. The reaction mixture is then quenched using aqueous hydrochloric acid until reaching a pH ca. 5 and the reaction mixture is stirred for an additional 30 min. Finally adjust to pH=7 using aqueous sodium hydroxide. Solvent removal and further purification then provides 4-iodo-N,N-dimethyltryptamine.

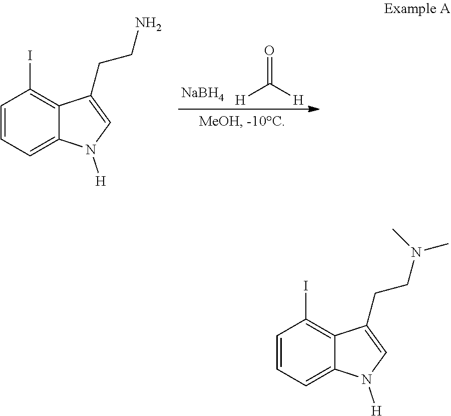

It should be noted that although the literature reports that this direct reductive amination works poorly or not at all leading to variations of the Eschweiler-Clarke reaction using sodium cyanoborohydride, it is actually possible to achieve good yields of the disubstituted tryptamines (while suppressing the Pictet-Spengler route to byproduct tryptolines by using a significant excess of formaldehyde) with sodium borohydride with the proper order of addition.

### Example B. Preparation of 4-pinacolboronate-N,N-dimethyltryptamine from 4-iodo-N,N-dimethyltryptamine

Bis(pinacolato)diboron (1.1 moles, 279.3 grams), potassium acetate (3 moles, 294.5 g) and [1,1′-Bis(diphenylphosphino)ferrocene]dichloropalladium(II) (3 mol. %, 22.0 grams) are stirred in 1 L of dioxane under argon. 4-iodo-N,N-dimethyltryptamine (1 mole, 315.2 grams) in dioxane is slowly added with stirring and the resulting reaction mixture is heated to 80° C. for 12 hours. The dioxane layer is separated and the aqueous layer extracted with two aliquots of ethyl acetate. The organic layers are combined and dried over anhydrous magnesium sulfate. The organics are stripped via evaporation and the resultant 4-pinacolboronate-N,N-dimethyltryptamine purified via distillation, if desired.

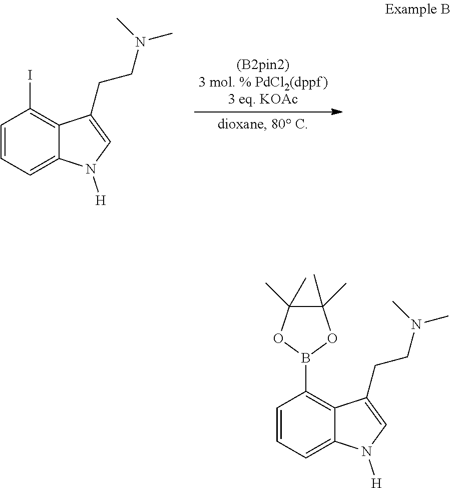

### Example C. Preparation of 4-trifluoroborate-N,N-dimethyltryptamine from 4-pinacolboronate-N,N-dimethyltryptamine

4-pinacolboronate-N,N-dimethyltryptamine (1.0 moles, 314.23 grams) is dissolved in ether and potassium hydrogen fluoride is added dropwise to produce 4-trifluoroborate-N,N-dimethyltryptamine. (Yuen and Hutton teach chemical modification of compounds related to pinacolyl boronate esters and intermediates including potassium trifluoroborates in Yuen, A. K., & Hutton, C. A. (2006). Deprotection of pinacolyl boronate esters via hydrolysis of intermediate potassium trifluoroborates. ChemInform, 37(6). https://doi.org/i0.1002/chin.200606174, incorporated by reference herein for information related to modification of boron molecules.)

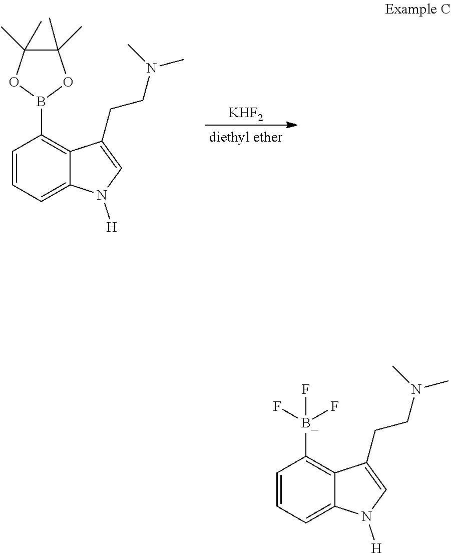

### Example D. Preparation of 4-boronic-N,N-dimethyltryptamine from 4-trifluoroborate-N,N-dimethyltryptamine

4-trifluoroborate-N,N-dimethyltryptamine (1.0 moles, 255.1 grams) is stirred in water and aqueous lithium hydroxide is added to produce 4-boronic-N,N-dimethyltryptamine. (Yuen and Hutton teach chemical modification of compounds related to pinacolyl boronate esters in Sun, J., Perfetti, M. T., & Santos, W. L. (2011). A method for the deprotection of alkylpinacolyl boronate esters. The Journal of Organic Chemistry, 76(9), 3571-3575. https://doi.org/10.1021/jo200250y, incorporated by reference herein for information related to modification of boron molecules.)

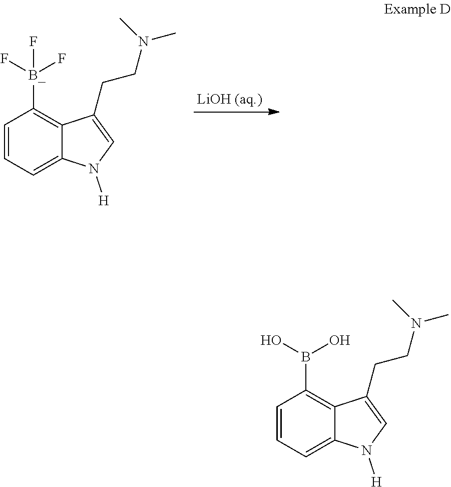

### Example E. Preparation of 4-boronic-N,N-dimethyltryptamine from 4-pinacolboronate-N,N-dimethyltryptamine

4-pinacolboronate-N,N-dimethyltryptamine (1.0 moles, 314.23 grams) is dissolved in ether. Diethanolamine (1.1 moles, 115.6 grams) is added at room temperature with stirring. A white precipitate forms and is filtered and dried. The dried powder is then dissolved in ether and 0.1 M HCl followed by stirring at room temperature to produce the 4-boronic-N,N-dimethyltryptamine. (Yuen and Hutton teach chemical modification of compounds related to pinacolyl boronate esters in Sun, J., Perfetti, M. T., & Santos, W. L. (2011). A method for the deprotection of alkylpinacolyl boronate esters. The Journal of Organic Chemistry, 76(9), 3571-3575. https://doi.org/10.1021/jo200250y, incorporated by reference herein for information related to modification of boron molecules.)

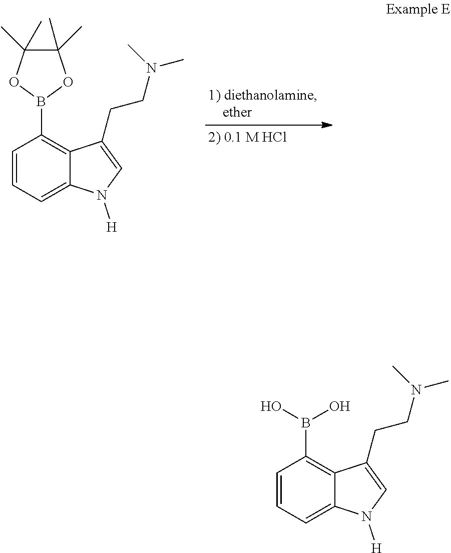

### Example F. Preparation of 5-bromo-N,N-dimethyltryptamine from 5-bromotryptamine

5-bromo-N,N-dimethyltryptamine (1 mole, 239.1 grams) is stirred in 1 L of methanol and chilled to −10° C. Sodium borohydride (2.5 mole, 94.6 grams) in 0.5 L of distilled water and formaldehyde (8.0 mole, 240.2 grams) as a 37% aqueous solution (stabilized with methanol) are then added at equal rates to the stirred and chilled 4-iodotryptamine solution at a rate that maintains the reaction temperature below 0° C. Upon adding the entirety of the sodium borohydride and formaldehyde solutions, the reaction is then stirred for an additional one hour. The reaction mixture is then quenched using aqueous hydrochloric acid until reaching a pH ca. 5 and the reaction mixture is stirred for an additional 30 min. Finally adjust to pH=7 using aqueous sodium hydroxide. Solvent removal and further purification then provides 5-bromo-N,N-dimethyltryptamine

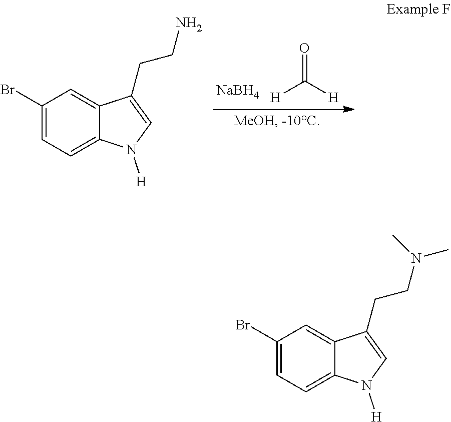

### Example G. Preparation of 5-pinacolboronate-N,N-dimethyltryptamine from 5-bromo-N,N-dimethyltryptamine

Bis(pinacolato)diboron (1.1 moles, 279.3 grams), potassium acetate (3 moles, 294.5 g) and 1,1′-Bis(diphenylphosphino)ferrocene]dichloropalladium(II) (3 mol. %, 22.0 grams) are stirred in 1 L of dioxane under argon. 5-bromo-N,N-dimethyltryptamine (1 mole, 267.2 grams) in dioxane is slowly added with stirring and the resulting reaction mixture is heated to 80° C. for 12 hours. The dioxane layer is separated and the aqueous layer extracted with two aliquots of ethyl acetate. The organic layers are combined and dried over anhydrous magnesium sulfate. The organics are stripped via evaporation and the resultant 5-pinacolboronate-N,N-dimethyltryptamine is purified via distillation, if desired.

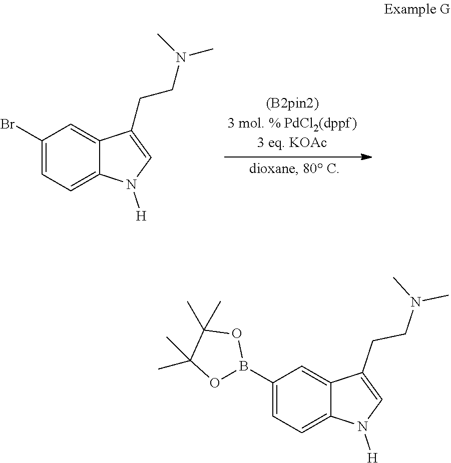

### Example H. Preparation of 5-trifluoroborate-N,N-dimethyltryptamine from 5-pinacolboronate-N,N-dimethyltryptamine

5-pinacolboonate-N,N-dimethyltryptamine (1.0 moles, 314.23 grams) is dissolved in ether and potassium hydrogen fluoride is added dropwise to produce 5-trifluoroborate-N,N-dimethyltryptamine. (Yuen and Hutton teach chemical modification of compounds related to pinacolyl boronate esters and intermediates including potassium trifluoroborates in Yuen, A. K., & Hutton, C. A. (2006). Deprotection of Pinacolyl boronate esters via hydrolysis of intermediate potassium trifluoroborates. ChemInform, 37(6). https://doi.org/I0.1002/chin.200606174, incorporated by reference herein for information related to modification of boron molecules.)

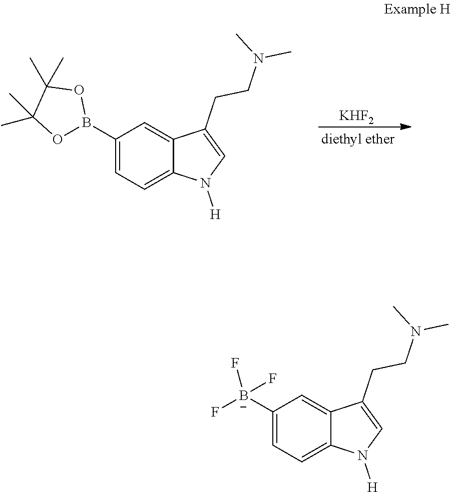

### Example I. Preparation of 5-boronic-N,N-dimethyltryptamine from 5-trifluoroborate-N,N-dimethyltryptamine

5-trifluoroborate-N,N-dimethyltryptamine (1.0 moles, 255.1 grams) is stirred in water and aqueous lithium hydroxide is added to produce 5-boronic-N,N-dimethyltryptamine. (Yuen and Hutton teach chemical modification of compounds related to pinacolyl boronate esters in Sun, J., Perfetti, M. T., & Santos, W. L. (2011). A method for the deprotection of alkylpinacolyl boronate esters. The Journal of Organic Chemistry, 76(9), 3571-3575. https://doi.org/10.1021/jo200250y, is incorporated by reference herein for information related to modification of boron molecules.)

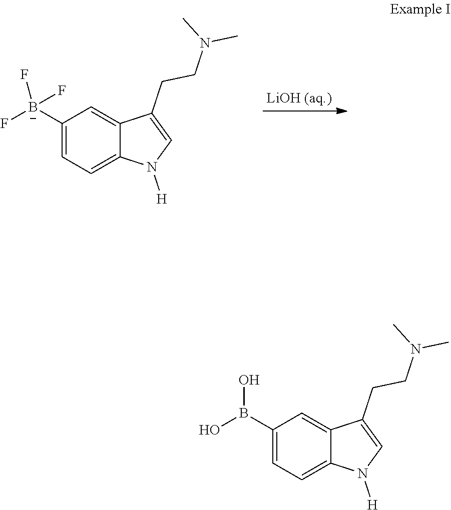 [SMILES: CN(C)CCc1c[nH]c2ccc([B-](F)(F)F)cc12 ; CN(C)CCc1c[nH]c2ccc(B(O)O)cc12]

### Example J. Preparation of 5-boronic-N,N-dimethyltryptamine from 5-pinacolboronate-N,N-dimethyltryptamine

5-pinacolboronate-N,N-dimethyltryptamine (1.0 moles, 314.23 grams) is dissolved in ether. Diethanolamine (1.1 moles, 115.6 grams) is added at room temperature with stirring. A white precipitate forms and is filtered and dried. The dried powder is then dissolved in ether and 0.1 M HCl followed by stirring at room temperature to produce the 5-boronic-N,N-dimethyltryptamine. (Yuen and Hutton teach chemical modification of compounds related to pinacolyl boronate esters in Sun, J., Perfetti, M. T., & Santos, W. L. (2011). A method for the deprotection of alkylpinacolyl boronate esters. The Journal of Organic Chemistry, 76(9), 3571-3575. https://doi.org/10.1021/jo200250y, incorporated by reference herein for information related to modification of boron molecules.)

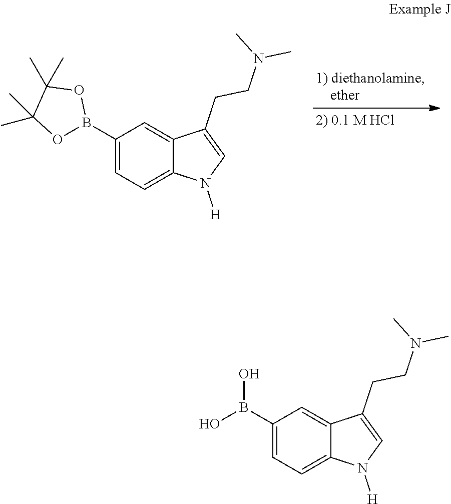

### Example K. Preparation of 3-(2-(dimethylamino)ethyl)-1H-indol-4-yl dihydrogen borate from 4-hydroxy-N,N-dimethyltryptamine (psilocin)

Psilocin (1.0 moles, 204.7 grams) and boric acid (3.1 moles, 191.7 grams) are stirred in aqueous ethanol and heated to 80° C. for 1 hour with stirring and then evaporated to dryness under reduced pressure. Excess moisture is removed using a chamber of calcium sulfate in-line with the vacuum pump resulting in preparation of 3-(2-(dimethylamino)ethyl)-1H-indol-4-yl dihydrogen borate via direct borylation where the product can exist as a monomer (shown in Scheme K), dimer, trimer (tryptamine borate ester), borate anion (pH dependent) or as an N—B dative bond adduct.

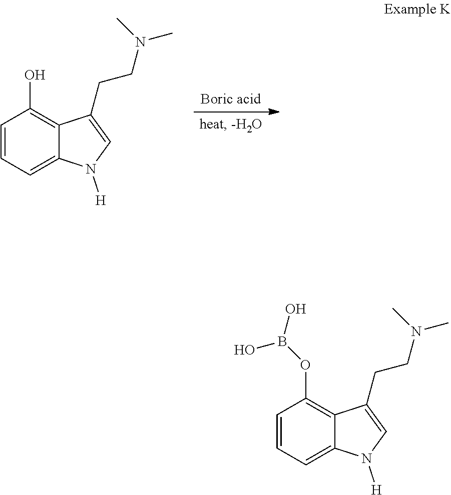 [SMILES: CN(C)CCc1c[nH]c2cccc(O)c12 ; CN(C)CCc1c[nH]c2cccc(OB(O)O)c12]

Psilocin is isolated and purified from the mycelia or fruiting bodies of Psilocybe spp via a simple aqueous-organic extraction paired with a dephosphorylation step to convert all psilocybin to psilocin as described by Casale (Casale J. F. 1985). Casale J F. An aqueous-organic extraction method for the isolation and identification of psilocin from hallucinogenic mushrooms. J Forensic Sci. 1985 January; 30(1):247-50. PMID: 4038992. which is incorporated herein by reference for its teaching for isolation and purification of psilocin. Alternatively, psilocin can be synthesized via the large-scale method reported by Shirota (Shirota, 2005). Shirota O, Hakamata W, and Goda Y. Concise Large-Scale Synthesis of Psilocin and Psilocybin, Principal Hallucinogenic Constituents of “Magic Mushroom” Journal of Natural Products 2003 66 (6), 885-887 DOI: 10.1021/np030059u, which is incorporated herein by reference for its teaching of the synthesis of psilocin and psilocybin.

### Example L. 3-(2-(dimethylamino)ethyl)-1H-indol-5-yl dihydrogen borate from 5-hydroxy-N,N-dimethyltryptamine (bufotenine)

Bufotenine (1.0 moles, 204.3 grams) and benzo[d][1,3,2]dioxaborol-2-ol (3.1 moles, 421.3 grams) are submitted to solvent-less Grindstone chemistry using hot rotor and stator surfaces. After the direct borylation is completed water is added and the reaction mixture heated to boiling to hydrolyze the catechol-boron B—O bonds followed by hot aqueous-organic extraction resulting in 3-(2-(dimethylamino)ethyl)-1H-indol-5-yl dihydrogen borate that can exist as a monomer (shown in Scheme L), dimer, trimer (tryptamine borate ester), or borate anion (pH dependent) where the byproduct catechol is removed in the aqueous layer.

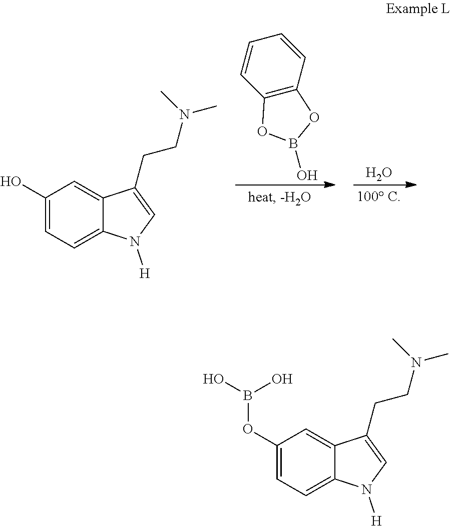

Bufotenine is isolated and purified from the seeds of Anadenanthera spp. according to the procedure of Stromberg (Stromberg, V. L. (1954). The isolation of bufotenine from Piptadenia Peregrina. Journal of the American Chemical Society, 76(6), 1707-1707, https://doi.org/10.1021/ja01635a082, incorporated herein by reference for its teaching for isolation and purification of tryptamines) or Moreira (Moreira, L. A., Murta, M. M., Gatto, C. C., Fagg, C. W., & Santos, M. L. (2015). Concise synthesis of N,N-dimethyltryptamine and 5-methoxy-N,N-dimethyltryptamine starting with bufotenine from Brazilian Anadenanthera SSP. Natural Product Communications, 10(4). https://doi.org/10.1177/1934578x1501000411, incorporated herein by reference for its teaching for isolation and purification of tryptamines.)

### Example M. Preparation of 8-(2-(dimethylamino)ethyl)-6H-[1,3,2]dioxaborolo[4,5-e]indol-2-ol from 3-(2-(dimethylamino)ethyl)-1H-indole-4,5-diol

3-(2-(dimethylamino)ethyl)-1H-indole-4,5-diol (1.0 moles, 220.3 grams) and boric acid (3.1 moles, 191.7 grams) are stirred in aqueous ethanol and heated to 80° C. for 1 hour with stirring and then evaporated to dryness under reduced pressure. Excess moisture is removed using a chamber of calcium sulfate in-line with the vacuum pump resulting in preparation of 8-(2-(dimethylamino)ethyl)-6H-[1,3,2]dioxaborolo[4,5-e]indol-2-ol via direct borylation.

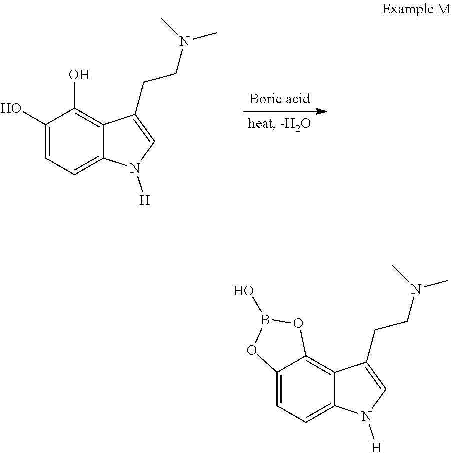 [SMILES: CN(C)CCc1c[nH]c2ccc(O)c(O)c12 ; CN(C)CCc1c[nH]c2ccc3c(c12)OB(O)O3]

### Uses of Boron Tryptamine Analogues

Brain or Spinal Cord Cancer Treatment—Boron Neutron Capture Therapy (BNCT) Protocol

A boron analogue of tryptamine, such as 5-boronic-N,N-dimethyltryptamine, can be administered as a two hour intravenous infusion using boron tryptamine analogue dosages at a therapeutically effective level (for example, ranging from 100 to 800 mg/kg) prior to neutron beam irradiation. Neutron beam irradiation can then be given as a single fraction from two fields. The average planning target volume dose can range, for example, from 15 to 100 Gy (W), and the average normal brain dose from 1.5 to 10 Gy (W).

Alternatively to administration by IV, the boron tryptamine analogue, such 4-boronic-N,N-dimethyltryptamine, can be administered orally, rectally, directly injected etc. Example dosage forms that can be administered orally include pills, tablets, capsules, granules, gelcaps, dragées, sublinguals, liquid, etc.

Treatment for Cancer other than Brain Cancer.

In addition to various types of brain cancers, especially glioblastoma, BNCT can be used for a number cancer types beyond those located in the brain, including cancers of the head or neck and lung cancers, breast cancers, hepatocellular carcinoma, sarcomas, cutaneous malignancies, extramammary Paget's disease, recurrent cancers, pediatric cancers, and metastatic disease. Treatment includes administering a therapeutically-effective dose of boron tryptamine analogue to the patient to concentrate the boron tryptamine analogue agent in the tumor. Suitable methods can include direct injection at the tumor site, IV, oral, suppository, etc.

During or after administration of the boron tryptamine analogue and when the boron tryptamine analogue concentrates in the tumor or adjacent to the tumor, neutron irradiation is commenced, with the neutrons preferentially absorbing in the cancerous tissue resulting in the killing of the cancerous cells.

Targeting Cancer Tissue with the Boron Tryptamine Analogues

Serotonin (5-hydroxytrypatmine, 5-HT) and 5-HT receptors play an important role in tumorigenesis. Mechanistic work indicates a stimulatory effect of serotonin on cancer cell proliferation, invasion, dissemination, and tumor angiogenesis such that serotonin levels in the tumor and its interaction with some 5-HT receptor subtypes

Boron tryptamine analogues can be serotonin analogues and, as such, possess many properties similar to those of serotonin including similar interactions with 5-HT receptors and interacting with the same 5-HT receptor subtypes as agonists, antagonists, inverse agonists, partial agonists, etc. With this property, boron tryptamine agonists can target and/or concentrate in tissues or portions of a body that have 5-HT receptors, including cancerous tissues.

### Proteasome Inhibition.

Boronic acids present in boron tryptamine analogues, as in embodiments of the compounds of Formulas I-V described herein, can be used as active isoteres of carboxylic acids, with these boronic acids in forms of compounds of Formulas I-V having a functional relationship similar to carboxylic acid groups, and in some embodiments forming specific and high-affinity bonds with amino acid residues, such as threonine and serine, in enzyme active sites that change or extinguish the activity of these enzymes, acting as a proteasome inhibitor. In some embodiments, boron tryptamine analogues described herein can be used as a proteasome inhibitor in the treatment of cancer. Such treatment can have a mechanism of action the same as, similar to, analogous to or different from that of bortezomib.

This characteristic can be utilized in combination with the serotonin analogue characteristics of boron tryptamine characteristic described in Exemplary Use 3 herein for targeting and concentrating the boron tryptamine analogue at cancerous tissue.

Simultaneous Treatment for Mental Health Alone or in Combination with Other Therapeutics or Wellness Regimens

Boron tryptamine analogues can exhibit psychoactive properties, as psilocybin analogues, or in some cases as orally-active psilocin prodrugs. Accordingly, boron tryptamine analogues can be used in the treatment of mental health issues, such as a treatment for depression, anxiety, PTSD, past traumatic events, alcoholism, other forms of addiction, etc. Such treatment with boron tryptamine analogues can be a stand-alone treatment (e.g. solely for addressing a mental health condition) or combined with other therapeutic agents and/or assisted therapy.

In some embodiments, boron tryptamine analogues can be utilized to provide treatment of a mental health issue together with treatment of a non-mental health issue such as immune dysfunction, inadequate healing or intractable pain. Examples of other physical disorders include cancer and other disorders that can be treated, co-treated or managed with a proteasome inhibitor. In a related example, inadequate or dysfunctional autophagy can be addressed with certain boron tryptamine analogues. In some embodiments, there can be a relationship between the mental health issue and the physical disorder, for example stress, anxiety and/or depression related to a diagnosis or treatment of a physical disorder, for example a life-threatening disorder such as cancer. In some embodiments, there is no relationship or no known relationship between the mental health issue and the physical disorder. In some embodiments, the mental health issue can be an issue the subject has experienced for a long time while the physical disorder can have a more recent origin. In some embodiments, the physical disorder can have led to the mental health issue. In other embodiments, the origin of the physical disorder can be prior to the origin of the mental health issue or can be simultaneous or approximately simultaneous.

In some embodiments, boron tryptamine analogues can provide simultaneous treatment of physical disorders, such as immune dysregulation, including cancer, and other disorders as described herein, such as intractable or recurrent pain, and treatment of mental health issues, including mental health issues associated with cancer diagnosis and treatment, such as depression and end-of-life anxiety.

### EXEMPLARY EMBODIMENTS

1. A compound of

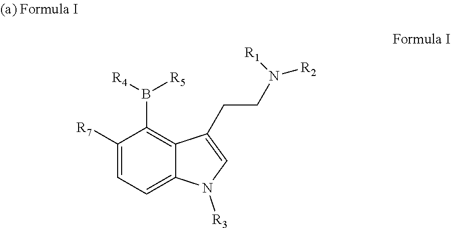

or a salt, stereoisomer, hydrate, solvate, or prodrug thereof;

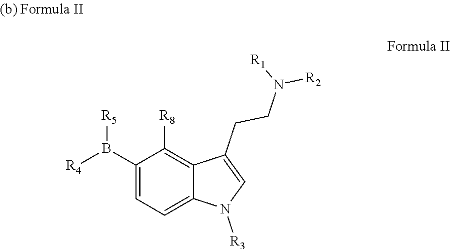

or a salt, stereoisomer, hydrate, solvate, or prodrug thereof;

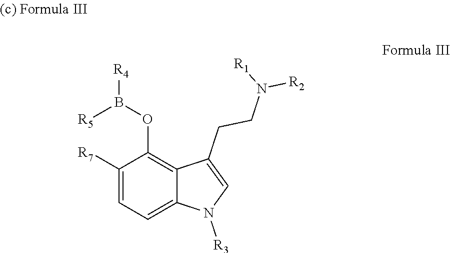

or a salt, stereoisomer, hydrate, solvate, or prodrug thereof;

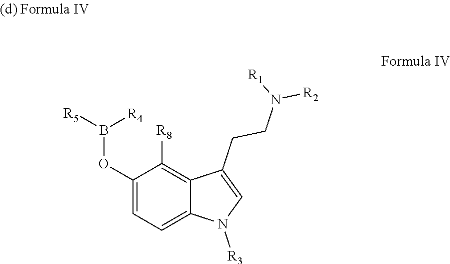

or a salt, stereoisomer, hydrate, solvate, or prodrug thereof; or

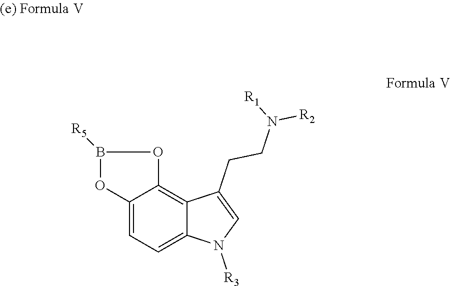

or a salt, stereoisomer, hydrate, solvate, or prodrug thereof;
wherein: R₁ and R₂ are independently H, C₁ to C₁₂ hydrocarbon, C₁ to C₁₂ substituted hydrocarbon, C, to C₆ hydrocarbon or C₁ to Ce substituted hydrocarbon;
R₃ is independently H, C₁ to C₁₂ hydrocarbon, C₁ to C₁₂ substituted hydrocarbon, C₁ to C₆ hydrocarbon, C₁ to C₆ substituted hydrocarbon, or a protecting group;
R₄ and R₅ are independently halogen, H, OH, OR₆, C₁ to C₁₂ hydrocarbon, C₁ to C₁₂ substituted hydrocarbon, C₁ to C₆ hydrocarbon, C₁ to C₆ substituted hydrocarbon, C₅ to C₁₂ aryl, C₂ to C₁₂ heterocyclic, C₄ to C₁₂ heteroaryl;
R₆ is a hydrocarbon, substituted hydrocarbon C₁ to C₁₂ hydrocarbon, C₁ to C₁₂ substituted hydrocarbon, C₁ to C₆ hydrocarbon or C₁ to C₆ substituted hydrocarbon; and
R₇ and R₈ are independently halogen, H, OH, OR₆, C₁ to C₁₂ hydrocarbon, C₁ to C₁₂ substituted hydrocarbon, C₁ to C hydrocarbon or C₁ to C₆ substituted hydrocarbon.
2. The compound or a salt, stereoisomer, hydrate, or solvate thereof of embodiment 1, wherein the compound or a salt, stereoisomer, hydrate, or solvate thereof is in a solid form or liquid form.
3. The compound or a salt, stereoisomer, hydrate, or solvate thereof of embodiment 1 or 2, wherein the compound or a salt, stereoisomer, hydrate, or solvate thereof is in a crystalline form or a non-crystalline form.
4. The compound or a salt, stereoisomer, hydrate, or solvate thereof of any one of embodiments 1-3, wherein the protecting group is selected from the group consisting of tert-butyloxycarbonyl (BOC), fluorenylmethoxycarbonyl (Fmoc), benzyloxymethyl acetal (BOM), methoxymethyl group (MOM), benzyl, and acetyl.
5. A composition comprising the compound or a salt, stereoisomer, hydrate, or solvate thereof of any one of embodiments 1-4, and optionally a carrier.
6. A pharmaceutical composition comprising the compound or a salt, stereoisomer, hydrate, or solvate thereof of any one of embodiments 1-4, and optionally a pharmaceutically acceptable carrier.
7. The pharmaceutical composition of embodiments 5 or 6, wherein the composition is formulated in a dosage form.
8. The pharmaceutical composition of embodiment 7, wherein the dosage form comprises a solid dosage form, a semi-solid dosage form, a liquid dosage form, or a suspension dosage form.
9. The pharmaceutical composition of embodiment 8, wherein the solid dosage form comprises a tablet, a dragee, a capsule, a pill, or a granule.
10. The pharmaceutical composition of any one of embodiments 7-9, wherein the composition is formulated in the dosage form is formulated to be administered orally, respiratorily, intranasally, topically, transdermally, intravenously, intramuscularly, rectally, or subcutaneously.
11. A method of treating a subject in need thereof, wherein the method comprises administering the pharmaceutical composition of any one of embodiments 6-10 to the subject.
12. The method of embodiment 11, wherein the subject is suffering from migraine, headache, cancer, depression, anxiety, post-traumatic stress disorder or a lack of well-being.
13. A method of preparing the compound or a salt, stereoisomer, hydrate, or solvate thereof of any one of embodiments 1-4, wherein the method comprises reacting a tryptamine analogue comprising a halogen at the C₄ or C₅ position with sodium borohydride in formaldehyde.
14. A method of preparing the compound or a salt, stereoisomer, hydrate, or solvate thereof of any one of embodiments 1-4, wherein the method comprises reacting a tryptamine analogue comprising a halogen at the C₄ or C₅ position with a boron-containing reagent in the presence of palladium.
15. The method of embodiment 14, wherein the boron-containing reagent comprises bis(pinacolato)diboron.
16. A method of preparing the compound or a salt, stereoisomer, hydrate, or solvate thereof of any one of embodiments 1-4, wherein the method comprises a dehydration reaction of a tryptamine analogue comprising an oxygen at the C₄ or C₅ position and a boron-containing reagent.

### Definitions

Embodiments discussed in the present disclosure include combinations of boron and tryptamine derivatives.

Boron can act as a neutron absorber, and this characteristic can be used in some situations as a way of treating cancer. Boron Neutron Capture Therapy (BNCT) relies upon targeting molecules containing boron (e.g. ¹⁰B) to a cancerous mass and then directing a beam of neutrons to the cancerous mass. The boron molecules then absorb the neutrons (i.e. alpha particles) thus creating heat in the process, which ablates or otherwise kills or inactivates surrounding tissue. Currently, two BNCT delivery agents are approved by FDA—boronophenylalanine and sodium borocaptate—and each has its limitations. It is desirable to find boron molecules and delivery systems that are both safe and effective at delivering boron preferentially and in sufficiently high concentrations to desired locations such as areas of the brain and/or to fast-growing tissues.

To deliver the boron or boron-containing molecule to a cancer in the brain, it can be desirable for the boron or boron-containing molecule to cross the blood-brain barrier. Many tryptamines are sufficiently lipophilic and of sufficiently low molecular weight to cross the blood-brain barrier via passive diffusion. Desirable levels of lipophilicity can be described in terms of a partitioning between octanol and water (Partition Coefficient, P=[Compound]_{octanol}/[Compound]_{water}, and Log P=log₁₀ (Partition Coefficient), with desirable degrees of lipophilicity having Log P of about 1.5-2.7 or about 1.3-2.9 or about 1.7-2.5. Desirable molecular weights can be less than about 600 Da, or less than about 800 Da or less than about 500 Da or less than about 400 Da or about 100-500 Da or about 200-600 Da or about 240-650 Da. Traversing the blood-brain barrier can be a major challenge that central nervous system therapeutics must overcome. Further, some forms of tryptamine compounds have been demonstrated to be psychoactive, and therefore can affect the brain and/or enter the brain.

Tryptamines are a class of 3-aminoethyl-indoles that bind and activate the serotonin receptor, also called the 5HT receptor. A psychedelic state may be achieved by activation of the 2A form of the serotonin receptor by 5HT2A receptor agonist compounds. The endogenous substance for this receptor is 5-hydroxy-tryptamine (serotonin). The tryptamine 3-(2-aminoethyl)-indole is also an endogenous neurotransmitter.

The serotonin receptor system is implicated in depression and depressive states which are commonly treated with 5HT1A antagonists (Affective Disorders: Depression in Neuropsychopharmacology and Therapeutics, Chapter 6, First Edition. Ivor S. Ebenezer, 2015). More recently, 5HT2A agonists have shown potential as medicines for depression (Carhart-Harris 2018 Psychopharmacology).

Tryptamine molecules which produce a psychedelic state and which have been used in traditional medicine, may have therapeutic potential for the treatment of mood disorders, distress, depression and others. For example, ayahuasca is a natural form of dimethyltryptamine (DMT) which when combined with a monoamine oxidase inhibitor can be ingested (made orally-available by preventing the degradation of DMT by monoamine oxidases, MAO, in the alimentary canal) and produces a variable, but prolonged psychedelic state that can last for 6 to 15 hours. DMT has also been reported to occur naturally in small amounts in the brain and may act as a neurotransmitter.

Lysergic acid diethylamide (LSD), is a diethylamide derivative of a naturally occurring substance from fungus found in rye grain, which also produces a prolonged psychedelic state up to 8 to 12 hours long.

Psilocybin is a naturally occurring plant-based tryptamine found in Psilocybe ssp. mushrooms, as well as other genera, and produces a prolonged psychedelic state of about 6 to 8 hours. Psilocybin was first synthesized in 1958 and is currently being investigated as a treatment for depression. Psilocybin is generally believed to be a prodrug, with psilocin being the active species in vivo. Psilocybin contains a phosphate bound to the 4-hydroxy group of psilocin, which is generally understood to be at least partially cleaved in the gut (after surpassing areas of MAO activity) as the pH increases and becomes more basic with passage into the intestines when the naturally-occurring or synthetic drug substance is consumed orally:

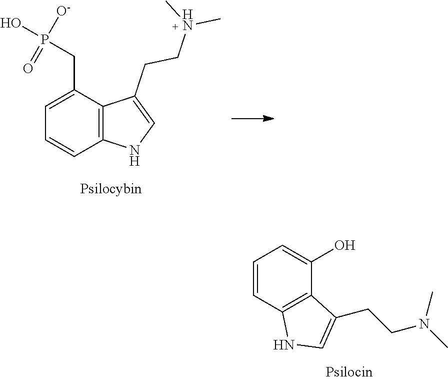

Simple mono-functional organic esters of psilocin, sulfate-bound psilocin and mono- and di-basic mineral acid modified psilocins have been described. Psilocin acetate (4-AcO-DMT) is an example of the simplest (i.e. acetoxy) ester of psilocin and is not found naturally-occurring. It has been utilized in academic studies as an alternate psilocin prodrug to psilocybin, which is more labile. Importantly, although the subjective effects of 4-AcO-DMT are similar to psilocin and psilocybin they are not the same with some patients reporting fewer adverse effects, or degree thereof, such as nausea or body load, compared to psilocin or psilocybin derived from natural or synthetic sources. Similar but not the same activity can be useful in pharmacology research for teasing apart fine differences between the biochemistry of related compounds and they can also be useful in the clinic where a slightly different effect profile can mean the difference between therapeutic success and failure for specific indications or populations (Palamar, 2020).

Psychedelic substances have been shown to be effective for treating depression, and even more effective for treating depression when associated with psychotherapy (Watts 2020 J Contextual Behavioral Science).

A limited number of synthetic tryptamine substances have been prepared since perhaps the earliest recorded work of Albert Hoffman and the later substantial and skilled work of Alexander Shulgin to extend the catalogue of known tryptamines. Structure-activity relationships have been described for a variety of tryptamine substances.

Succinate and other diacid functions have been explored as components of a prodrug delivery system toward water-soluble, injectable forms of hydrophobic or poorly water soluble drug substances, such as testosterone, haloperidol, chloramphenicol or estradiol (Silverman and Holladay, Chapter 9.2: Prodrugs and Drug Delivery Systems in The Organic Chemistry of Drug Design and Drug Action (3.sup.rd Ed), 2014). Tetrahydrocannabinol ester of succinic acid has been patented to treat glaucoma. However, ester cleavage is not consistently rapid, is not predictable and can depend on the structure of the moiety attached to the drug and therefore must be investigated (Anderson 1984 JPharmaSci). Esterase enzymes are responsible for active cleavage of the prodrug ester group in vivo and inter- and intra-species differences in esterase quantities and specificity in various tissues complicate investigations and optimizations (Bahar 2012 JPharmSci).

However, at least some tryptamines can be metabolized in the human digestive tract by monoamine oxidases (MAO) presenting a barrier to maintaining the oral activity of therapeutics containing the tryptamine motif such as where tryptamine compounds, such as dimethyltryptamine, can be orally inactive due to metabolization by MAOs in the human digestive tract. This potential for inactivation often leads to additional measures becoming necessary, such as co-administration with an MAO inhibitor (MAOi), to secure oral activity. It is desirable to find non-toxic compounds that can overcome some of these deficiencies of the tryptamine class while also maintaining CNS effects.

Unless specific definitions are provided, the nomenclature used in connection with, and the procedures and techniques of, analytical chemistry, synthetic organic chemistry, and medicinal and pharmaceutical chemistry described herein are those well-known and commonly used in the art. Standard techniques may be used for chemical synthesis, and chemical analysis.

Unless otherwise indicated, the following terms have the following meanings:

“Aqueous solution” means a solution comprising one or more solutes in water. In certain embodiments, the water is sterile water. In certain embodiments, an aqueous solution is saline.

“Entirely free” (i.e. not “consisting of” terminology) means that within the detection range of the instrument or process being used, the substance cannot be detected or its presence cannot be confirmed.

“Essentially free” (or “consisting essentially of”) means that only trace amounts of the substance can be detected.

“Excipient” means a substance present in a pharmaceutical composition other than the active pharmaceutical ingredient present in the pharmaceutical composition. An excipient can be a buffer, carrier, stabilizer, preservative, diluent, vehicle, and/or a bulking agent, such as an albumin, gelatin, collagen and/or sodium chloride.

“Patient” means a human or non-human subject receiving medical or veterinary care. Accordingly, as disclosed herein, the compositions may be used in treating any animal, such as mammals.

“Pharmaceutical composition” means a formulation in which a pharmaceutically active ingredient is present. The word “formulation” means that there is at least one additional ingredient in the pharmaceutical composition besides a pharmaceutically active ingredient. A combination of more than one pharmaceutically active ingredients can be a “formulation.” A pharmaceutical composition is therefore a formulation which is suitable for diagnostic, therapeutic or cosmetic use (i.e. by intramuscular or subcutaneous injection or by insertion of a depot or implant) to a subject, such as a human patient. The pharmaceutical composition can be: in a lyophilized or vacuum dried condition; a solution formed after reconstitution of the lyophilized or vacuum dried pharmaceutical composition with saline or water, or; as a solution which does not require reconstitution. As stated, a pharmaceutical composition can be liquid or solid, for example vacuum-dried. The constituent ingredients of a pharmaceutical composition can be included in a single composition (that is all the constituent ingredients, except for any required reconstitution fluid, are present at the time of initial compounding of the pharmaceutical composition) or as a two-component system, for example a vacuum-dried composition reconstituted with a diluent such as saline which diluent contains an ingredient (such as water) not present in the initial compounding of the pharmaceutical composition.

“Substantially free” means present at a level of less than one percent by weight of the pharmaceutical composition.

“Therapeutic formulation” means a formulation can be used to treat and thereby alleviate a disorder, disease or other medical condition.

“Aromatic compound” refers to a mono- or polycyclic carbocyclic ring system having one or more aromatic rings. Preferred aromatic ring systems have from about 5 to about 20 carbon atoms in one or more rings. Aromatic groups as used herein may optionally include further substituent groups.

“Heterocyclic compound” as used herein, refers to a mono-, or poly-cyclic ring system that includes at least one heteroatom and is unsaturated, partially saturated, or fully saturated, thereby including heteroaryl groups and heterocyclic aromatic compounds. Heterocyclic compound is also meant to include fused ring systems wherein one or more of the fused rings contain at least one heteroatom and the other rings can contain one or more heteroatoms or optionally contain no heteroatoms. A heterocyclic compound typically includes at least one atom selected from sulfur, nitrogen or oxygen. In certain embodiments, a heterocyclic compound may include one or more rings, wherein each ring has one or more heteroatoms. In certain embodiments, a heterocyclic compound includes a monocyclic ring system with one or more heteroatoms. In certain embodiments, a heterocyclic compound includes a monocyclic ring system with two or more heteroatoms. Examples of heterocyclic compounds include, but are not limited to, [1, 3]dioxolane, pyrrolidine, pyrazoline, pyrazolidine, imidazoline, imidazolidine, piperidine, piperazine, oxazolidine, isoxazolidine, morpholine, thiazolidine, isothiazolidine, quinoxaline, pyridazinone, tetrahydrofuran and the like. Heterocyclic compounds as used herein may optionally include further substituent groups.

“Heterocyclic aromatic compound” means any compound comprising a mono- or poly-cyclic aromatic ring system or fused ring system wherein at least one of the rings is aromatic and includes one or more heteroatoms. Heterocyclic aromatic compounds also encompass fused ring systems, including systems where one or more of the fused rings contain no heteroatoms. Heterocyclic aromatic compounds typically include one ring atom selected from sulfur, nitrogen or oxygen. Examples of heterocyclic aromatic compounds groups include without limitation, pyridine, pyrazine, pyrimidine, pyrrole, pyrazole, imidazole, thiazole, oxazole, isooxazole, thiadiazole, oxadiazole, thiophene, furan, quinoline, isoquinoline, benzimidazole, benzooxazole, quinoxaline and the like. Heterocyclic aromatic compounds can be attached to a parent molecule directly or through a linking moiety such as an aliphatic group or hetero atom. Heterocyclic aromatic compounds as used herein may optionally include further substituent groups.

“Chemical modification” means a chemical difference in a compound when compared to a naturally occurring counterpart. In reference to an oligonucleotide, chemical modification does not include differences only in nucleobase sequence. Chemical modifications of oligonucleotides include nucleoside modifications (including sugar moiety modifications and nucleobase modifications) and internucleoside linkage modifications. In reference to small organic molecules, chemical modification includes the addition, subtraction, rearrangement or change of oxidation state of at least one atom.

“Furanosyl” means a structure comprising a 5-membered ring comprising four carbon atoms and one oxygen atom.

“Oligomeric compound” means a polymeric structure comprising two or more sub-structures. In certain embodiments, an oligomeric compound comprises an oligonucleotide. In certain embodiments, an oligomeric compound comprises one or more conjugate groups and/or terminal groups. In certain embodiments, an oligomeric compound consists of an oligonucleotide.

“Conjugate” means an atom or group of atoms bound to an active pharmaceutical ingredient (API) or some other core pharmacologically-active molecule. In general, conjugate groups modify one or more properties of the compound to which they are attached, including, but not limited to pharmacodynamic, pharmacokinetic, binding, absorption, cellular distribution, cellular uptake, charge and/or clearance properties.

“Essentially unchanged” means little or no change in a particular parameter, including situations where change is relative to another parameter which changes much more. In certain embodiments, a parameter is essentially unchanged when it changes less than 5%. In certain embodiments, a parameter is essentially unchanged if it changes less than two-fold while another parameter changes at least ten-fold. For example, in certain embodiments, an antisense activity is a change in the amount of a target nucleic acid. In certain such embodiments, the amount of a non-target nucleic acid is essentially unchanged if it changes much less than the target nucleic acid does, but the change need not be zero.

“Motif” or “moiety” means a subunit of a molecule or API. Specific moieties of a class of molecules are often targeted for modification when structure-activity relationship (SAR) work has demonstrated certain functional properties of a substance to be largely impacted by chemical differences in a specific subunit.

“Differently modified” means chemical modifications or chemical substituents that are different from one another, including absence of modifications. “Differently modified” includes molecules that have such differences even when one of the molecules being considered is unmodified and when one is not made from the other. Likewise, two unmodified molecules that fit this description are also “differently modified.

“The same type of modifications” refers to modifications that are the same as one another, including absence of modifications.

“Pharmaceutically acceptable carrier or diluent” means any substance suitable for use in administering to an animal or person. In certain embodiments, a pharmaceutically acceptable carrier or diluent is sterile saline. In certain embodiments, such sterile saline is pharmaceutical grade saline.

“Substituent” and “substituent group, “mean an atom or group that replaces the atom or group of a named parent compound. Substituents may also be further substituted with other substituent groups and may be attached directly to a parent group or indirectly via a linking group such as an alkyl, polyether, hydrazone, cathepsin B-cleavable peptide, disulfide-containing, or pyrophosphate ester linker.

“Substituent” can also mean in reference to a chemical functional group an atom or group of atoms that differs from the atom or a group of atoms normally present in the named functional group. In certain embodiments, a substituent replaces a hydrogen atom of the functional group (e.g., in certain embodiments, the substituent of a substituted methyl group is an atom or group other than hydrogen which replaces one of the hydrogen atoms of an unsubstituted methyl group). Unless otherwise indicated, groups amenable for use as substituents include without limitation, halogen, hydroxyl, alkyl, alkenyl, alkynyl, acyl (—C(O)Rₐₐ), carboxyl (—C(O)O—Rₐₐ), aliphatic groups, alicyclic groups, alkoxy, substituted oxy (—O—Rₐₐ), aryl, aralkyl, heterocyclic radical, heteroaryl, heteroarylalkyl, amino (—N(R_{bb})(R_{cc})), imino(══NR_{bb}), amido (—C(O)N(R_{bb})(R_{cc}) or —N(R_{bb})C(O)Rₐₐ), azido (—N₃), nitro (—NO₂), cyano (—CN), carbamido (—OC(O)N(R_{bb})(R_{cc}) or —N(R_{bb})C(O)ORₐₐ), ureido (—N(R_{bb})C(O)N(R_{bb})(R_{cc})), thioureido (—N(R_{bb})C(S)N(R_{bb})—(R_{cc}), guanidinyl (—N(R_{bb})C(══NR_{bb})N(R_{bb})(R_{cc})), amidinyl (—C(═NR_{bb})N(R_{bb})(R_{cc}) or —N(R_{bb})C(═NR_{bb})(Rₐₐ)), thiol (—SR_{bb}), sulfinyl (—S(O)R_{bb}), sulfonyl (—S(O)₂R_{bb}) and sulfonamidyl (—S(O)₂N(R_{bb})(R_{cc}) or —N(R_{bb})S—(O)₂R_{bb}). Wherein each Rₐₐ, R_{bb} and Roe, is, independently, H, an optionally linked chemical functional group or a further substituent group with a preferred list including without limitation, alkyl, alkenyl, alkynyl, aliphatic, alkoxy, acyl, aryl, aralkyl, heteroaryl, alicyclic, heterocyclic and heteroarylalkyl. Selected substituents within the compounds described herein are present to a recursive degree.

“Alkyl” as used herein, means a saturated straight or branched hydrocarbon radical containing up to twenty four carbon atoms. Examples of alkyl groups include without limitation, methyl, ethyl, propyl, butyl, isopropyl, n-hexyl, octyl, decyl, dodecyl and the like. Alkyl groups typically include from 1 to about 24 carbon atoms, more typically from 1 to about 12 carbon atoms (C₁-C₁₂ alkyl) with from 1 to about 6 carbon atoms being more common.

“Alkenyl” means a straight or branched hydrocarbon chain containing up to twenty four carbon atoms and having at least one carbon-carbon double bond. Examples of alkenyl groups include without limitation, ethenyl, propenyl, butenyl, 1-methyl-2-buten-1-yl, dienes such as 1, 3-butadiene and the like. Alkenyl groups typically include from 2 to about 24 carbon atoms, more typically from 2 to about 12 carbon atoms with from 2 to about 6 carbon atoms being more common. Alkenyl groups as used herein may optionally include one or more further substituent groups.

“Alkynyl, “means a straight or branched hydrocarbon radical containing up to twenty four carbon atoms and having at least one carbon-carbon triple bond. Examples of alkynyl groups include, without limitation, ethynyl, 1-propynyl, 1-butynyl, and the like. Alkynyl groups typically include from 2 to about 24 carbon atoms, more typically from 2 to about 12 carbon atoms with from 2 to about 6 carbon atoms being more common. Alkynyl groups as used herein may optionally include one or more further substituent groups.

“Acyl, “means a carbonyl group that has the general Formula R—C(O)—X where R is most typically an aliphatic, alicyclic or aromatic hydrocarbon moiety or at least possesses a first carbon atom bonded with the carbon in the C(O) moiety, X is typically a group containing a first oxygen atom but can also include a first sulfur, halide or selenium atom, and “C(O)” refers to carbon double-bonded to an oxygen atom. Examples include aliphatic carbonyls, aromatic carbonyls, aliphatic sulfonyls, aromatic sulfinyls, aliphatic sulfinyls, aromatic phosphates, aliphatic phosphates, aliphatic/aromatic halides and the like. Acyl groups as used herein may optionally include further substituent groups.

“Alicyclic” means a cyclic ring system wherein the ring is aliphatic. The ring system can comprise one or more rings wherein at least one ring is aliphatic. Preferred alicyclics include rings having from about 5 to about 9 carbon atoms in the ring. Alicyclic as used herein may optionally include further substituent groups.

“Aliphatic” means a straight, cyclic or branched hydrocarbon containing up to twenty-four carbon atoms wherein the saturation between any two carbon atoms is a single, double or triple bond. Aliphatic is mutually-exclusive with aromatic. An aliphatic group preferably contains from 1 to about 24 carbon atoms, more typically from 1 to about 12 carbon atoms with from 1 to about 6 carbon atoms being more typical. The straight or branched chain of an aliphatic group may be interrupted with one or more heteroatoms that include nitrogen, oxygen, sulfur and phosphorus. Such aliphatic groups interrupted by heteroatoms include without limitation, polyalkoxys, such as polyalkylene glycols, polyamines, and polyimines. Aliphatic groups as used herein may optionally include further substituent groups.

“Alkoxy” means a functional group composed of an alkyl group and a terminal oxygen atom wherein the oxygen atom is used to attach the alkoxy group to a parent molecule to form other functional groups such as ethers, alkoxides, alcohols, amides, esters, acetals and hemiacetals. Examples of alkoxy groups include without limitation, methoxy, ethoxy, propoxy, isopropoxy, n-butoxy, sec-butoxy, tert-butoxy, n-pentoxy, neopentoxy, n-hexoxy and the like. Alkoxy groups as used herein may optionally include further substituent groups.

“Alkylamino” means an amino substituted C₁-C₁₂ alkyl moiety. The amino portion of the moiety typically forms a covalent bond with a parent molecule or other molecular subunit analogously to alkoxy groups. The amino group can be located at any position and the aminoalkyl group can be substituted with a further substituent group at the alkyl and/or amino portions.

“Aralkyl” and “arylalkyl” mean an aromatic group that is covalently linked to a C₁-C₁₂ alkyl group. The alkyl portion of the resulting aralkyl (or arylalkyl) group forms a covalent bond with a parent molecule. Examples include without limitation, benzyl, phenethyl and the like. Aralkyl groups as used herein may optionally include further substituent groups attached to the alkyl, the aryl or both groups that form the radical group.

“Aryl” and mean a mono- or polycyclic carbocyclic ring system having one or more aromatic rings. Examples of aryl groups include without limitation, phenyl, naphthyl, tetrahydronaphthyl, indanyl, idenyl and the like. Preferred aryl ring systems have from about 5 to about 20 carbon atoms in one or more rings. Aryl groups as used herein may optionally include further substituent groups.

“Halo” and “halogen” and “halide” mean an atom selected from fluorine, chlorine, bromine and iodine. The atom can be in the form of an ion, an atom or molecule (e.g. Cl or Cl₂) or covalently bonded as a part of a molecule (e.g. alkyl halide, or CH₃C₁.)

The term “hydrocarbon” refers to a compound containing entirely of hydrogen and carbon atoms including a linear, branched, branched, cyclic, saturated, or unsaturated aliphatic group, such as an alkane, alkene, or alkyne group, and including aromatic groups.

The term “substituted hydrocarbon” refers to a hydrocarbon with at least one substitution of an H with a group that is or includes a halogen, hydroxyl, ether, carbonyl, amino or sulfur.

The term “protecting group” refers to a derivative of an existing functional group in a compound, formed by a reversible chemical modification of the existing functional group for temporary protection of the functional group to prevent it from reacting under subsequent conditions. For example, protecting groups for an amine, such as at the R₃ position, include tert-butyloxycarbonyl (BOC), fluorenylmethoxycarbonyl (Fmoc), benzyloxymethyl acetal (BOM), methoxymethyl group (MOM), benzyl, or acetyl.

“Heteroaryl, “mean a radical comprising a mono- or poly-cyclic aromatic ring, ring system or fused ring system wherein at least one of the rings is aromatic and includes one or more heteroatoms. Heteroaryl is also meant to include fused ring systems including systems where one or more of the fused rings contain no heteroatoms. Heteroaryl groups typically include one ring atom selected from sulfur, nitrogen or oxygen. Examples of heteroaryl groups include without limitation, pyridinyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, benzimidazolyl, benzooxazolyl, quinoxalinyl and the like. Heteroaryl radicals can be attached to a parent molecule directly or through a linking moiety such as an aliphatic group or hetero atom. Heteroaryl groups as used herein may optionally include further substituent groups.

“Treating”, “treat” or “treatment” as used herein embraces both preventative, i.e., prophylactic, and palliative treatment, i.e., relieve, alleviate, or slow the progression of the patient's disease, disorder or condition.

“Psychedelic state” is an altered state of consciousness experienced by a person, which may include intensified sensory perception, perceptual distortion or hallucinations, and/or feelings of euphoria or despair. Psychedelic states have been described as resulting from psychedelic drugs such as DMT (dimethyltryptamine), LSD, mescaline or psilocybin. Other known psychedelic drugs include the 4-hydroxy analogs of N-methyl-N-isopropyltryptamine (MiPT) and N,N-diisopropyltryptamine (DiPT).

“Compounds” when used herein includes any pharmaceutically acceptable derivative or variation, including conformational isomers (e.g., cis and trans isomers) and all optical isomers (e.g., enantiomers and diastereomers), racemic, diastereomeric and other mixtures of such isomers, as well as solvates, hydrates, isomorphs, polymorphs, tautomers, esters, salt forms, and prodrugs. The expression “prodrug” refers to compounds that are drug precursors which following administration, release the drug (“active” or “API”)) in vivo via some chemical or physiological process (e.g., hydrolysis, enzymatic cleavage or hydrolysis, or metabolism is converted to the desired drug form). The invention includes within its scope the pharmaceutically acceptable salts of the compounds of the invention. Accordingly, the phrase “or a pharmaceutically acceptable salt thereof” is implicit in the description of all compounds described herein unless explicitly indicated to the contrary.

The term “analogue” (also structural analog or chemical analogue) is used to refer to a compound that is structurally similar to another compound but differs with respect to a certain component, such as an atom or a functional group.

The term “derivative” refers to a compound that is obtained from a similar compound or a precursor compound by a chemical reaction.

The term “boron” and its chemical symbol (i.e. “B”) refers to any suitable isotope for the particular use considered. The main isotopes of boron are ¹⁰B and ¹¹B but others are also known.

The most stable are ¹⁰B and ¹¹B. For BNCT applications, ¹⁰B and mixtures of isotopes that include ¹⁰B are most frequently used. In other applications, any suitable isotope can be used including ¹⁰B and ¹¹B and other isotopes as well as combinations thereof. In some uses, a naturally occurring mixture of isotopes can be used.

In some embodiments, the compounds of the present invention comprise prodrug compounds that are readily purified, formulated, acceptably non-toxic and stable, and preferably may be used to provide highly soluble drug substances, with fast onset and elimination for convenient use in a clinical setting. In some embodiments, the compounds may be produced as a zwitterion, which may be converted to a pharmaceutically acceptable salt.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated. While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof. Use of language such as “approximately”, “somewhat”, “about”, “nearly” and other terms of degree that appear within this disclosure are intended to be interpreted as a person of skill in the art would understand the language based upon the context, with a further understanding that if the context provides insufficient guidance, a tolerance of 20% should be applied. Ranges are inclusive unless the immediate context indicates otherwise.

1. A compound of 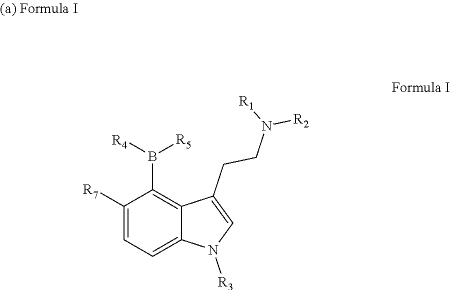
or a salt, stereoisomer, hydrate, solvate, or prodrug thereof; 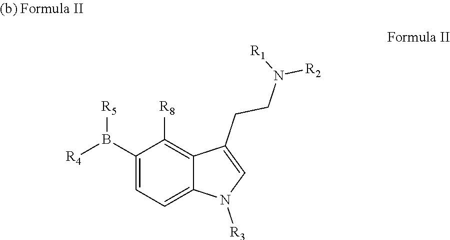
or a salt, stereoisomer, hydrate, solvate, or prodrug thereof; 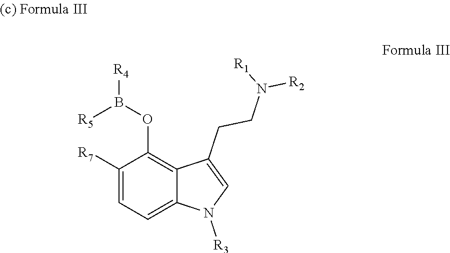
or a salt, stereoisomer, hydrate, solvate, or prodrug thereof; 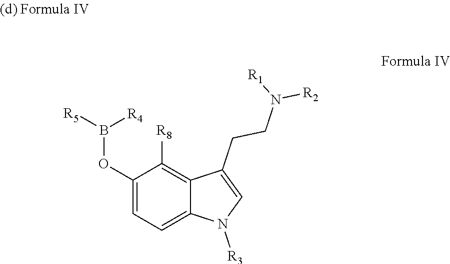
or a salt, stereoisomer, hydrate, solvate, or prodrug thereof; or 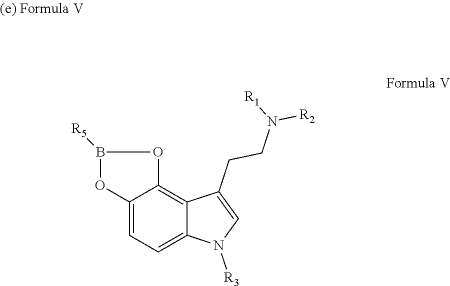
or a salt, stereoisomer, hydrate, solvate, or prodrug thereof;
wherein:
R₁ and R₂ are independently H, C₁ to C₁₂ hydrocarbon, or C₁ to C₁₂ substituted hydrocarbon;
R₃ is independently H, C₁ to C₁₂ hydrocarbon, C₁ to C₁₂ substituted hydrocarbon, or a protecting group;
R₄ and R₅ are independently halogen, H, OH, OR₆, C₁ to C₁₂ hydrocarbon, C₁ to C₁₂ substituted hydrocarbon, C₅ to C₁₂ aryl, C₂ to C₁₂ heterocyclic, C₄ to C₁₂ heteroaryl;
R₆ is a hydrocarbon; and
R₇ and R₈ are independently halogen, H, OH, OR₆, or C₁ to C₁₂ hydrocarbon.

2. The compound or a salt, stereoisomer, hydrate, or solvate thereof of claim 1, wherein the compound or a salt, stereoisomer, hydrate, or solvate thereof is in a solid form or liquid form.

3. The compound or a salt, stereoisomer, hydrate, or solvate thereof of claim 1 or 2, wherein the compound or a salt, stereoisomer, hydrate, or solvate thereof is in a crystalline form or a non-crystalline form.

4. The compound or a salt, stereoisomer, hydrate, or solvate thereof of any one of claims 1-3, wherein when R3 is a protecting group it is selected from the group consisting of tert-butyloxycarbonyl (BOC), fluorenylmethoxycarbonyl (Fmoc), benzyloxymethyl acetal (BOM), methoxymethyl group (MOM), benzyl, and acetyl.

5. A composition comprising the compound or a salt, stereoisomer, hydrate, or solvate thereof of any one of claims 1-4, and optionally a carrier.

6. A pharmaceutical composition comprising the compound or a salt, stereoisomer, hydrate, or solvate thereof of any one of claims 1-4, and optionally a pharmaceutically acceptable carrier.

7. The pharmaceutical composition of claim 6, wherein the composition is formulated in a dosage form.

8. The pharmaceutical composition of claim 7, wherein the dosage form comprises a solid dosage form, a semi-solid dosage form, a liquid dosage form, or a suspension dosage form.

9. The pharmaceutical composition of claim 8, wherein a solid dosage form comprises a tablet, a dragee, a capsule, a pill, or a granule.

10. The pharmaceutical composition of any one of claims 7-9, wherein the composition is formulated in a dosage form to be administered orally, respiratorily, intranasally, topically, transdermally, intravenously, intramuscularly, rectally, or subcutaneously.

11. A method of treating a subject in need thereof, wherein the method comprises administering the pharmaceutical composition of any one of claims 6-10 to the subject.

12. The method of claim 11, wherein the subject is suffering from migraine, headache, cancer, depression, anxiety, post-traumatic stress disorder or a lack of well-being.

13. A method of preparing the compound or a salt, stereoisomer, hydrate, or solvate thereof of of any one of claims 1-4, wherein the method comprises reacting a tryptamine analogue comprising a halogen at the C4 or C5 position with sodium borohydride in formaldehyde.

14. A method of preparing the compound or a salt, stereoisomer, hydrate, or solvate thereof of any one of claims 1-4, wherein the method comprises reacting a tryptamine analogue comprising a halogen at the C4 or C5 position with a boron-containing reagent in the presence of palladium.

15. The method of claim 14, wherein the diborane reagent comprises bis(pinacolato)diboron.

16. A method of preparing the compound or a salt, stereoisomer, hydrate, or solvate thereof of any one of claims 1-4, wherein the method comprises a dehydration reaction of a tryptamine analogue comprising an oxygen at the C4 or C5 position and a boron-containing reagent.
